(19) United States
(12) Patent Application Publication
(10) Pub. No.: US 2013/0117585 A1
(43) Pub. Date: May 9, 2013

(54) POWER SUPPLY DEVICE FOR SUPPLYING POWER VIA INTERNET NETWORK

(71) Applicants: Chih-Ming CHEN, Taipei (TW); Chian-Ting CHEN, Taipei (TW); Chung-Hao WANG, Taipei (TW); Chia-Chun CHIEN, Taipei (TW); Shih-Wen WU, Taipei (TW)

(72) Inventors: Chih-Ming CHEN, Taipei (TW); Chian-Ting CHEN, Taipei (TW); Chung-Hao WANG, Taipei (TW); Chia-Chun CHIEN, Taipei (TW); Shih-Wen WU, Taipei (TW)

(73) Assignee: INVENTEC CORPORATION, Taipei (TW)

(21) Appl. No.: 13/332,034

(22) Filed: Dec. 20, 2011

(30) Foreign Application Priority Data
Nov. 4, 2011 (TW) 100140394

(51) Int. Cl. G06F 1/26

(52) U.S. Cl. 713/310

(57) ABSTRACT

A power supply device for supplying power via internet network comprises a power supply unit and a power consumption unit. The power supply unit comprises a power source unit and a first processing unit. The power source unit provides a first voltage with a first power and a second voltage with a second power. The first processing unit detects a connection status of the power supply unit for controlling the power source unit to provide the first voltage, and controlling the power source unit to provide the second voltage according to a control signal. The power consumption unit comprises a connecting unit and a second processing unit. The connecting unit is for connecting the power source unit and the first processing unit. The second processing unit receives the first voltage via the connecting unit and provides the control signal according to the first voltage.

### CROSS-REFERENCE TO RELATED APPLICATIONS

This non-provisional application claims priority under 35 U.S.C. §119(a) on Patent Application No(s). 100140394 filed in Taiwan, R.O.C. on Nov. 4, 2011, the entire contents of which are hereby incorporated by reference.

### BACKGROUND

1. Technical Field

The present disclosure relates to a power device and more particularly to a power supply device for supplying power via internet network.

2. Related Art

As the application of internet continues to expand, communication over the internet is becoming more and more important to people. Broadband and connection speed of the internet are advancing dramatically as users are demanding larger amount of information via the internet. Today's video streaming is evolved from merely texts, black and white and color images in the old days. The internet is no longer only for transmitting information, and people have realized that the internet can be a media for supplying electric power via cables, such as Power over Ethernet (POE), which is a technology for transmitting electric power and data over the Ethernet via twisted-pair cables to devices.

Because additional sockets are not needed for electronic devices (e.g. laptops or desktop computers) to be supplied with electric power over the Ethernet, thus the time and money for getting power cords are also saved, and the costs of components can be reduced also. However, each port of an existing power sourcing equipment (PSE) for POE technology can only provide power of 12.95 W (for example 802.3af). Such standard is incapable for starting or running high power (higher than 12.95 W) demanded products which demand electric power over the Ethernet. Even though some products in the market under running status, can execute for example, the Link Layer Discovery Protocol (LLDP) via assess point (AP) under an operating system (OS) in order to be supplied with 25.5 W voltage through power sourcing equipment (PSE) for POE; high voltage power is still not available instantly for products which are switched off, thus its degree of convenience in application is reduced.

### SUMMARY

A power supply device for supplying power via internet network of the disclosure comprises a power supply unit and a power consumption unit. The power supply unit comprises a power source unit and a first processing unit. The power source unit provides a first voltage with a first power and a second voltage with a second power. The first processing unit is coupled to the power source unit for detecting a connection status of the power supply unit for controlling the power source unit to provide the first voltage, and controlling the power source unit to provide the second voltage according to a control signal. The power consumption unit comprises a connecting unit and a second processing unit. The connecting unit is for connecting the power source unit and the first processing unit. The second processing unit is coupled to the connecting unit for receiving the first voltage via the connecting unit and providing the control signal according to the first voltage.

In an embodiment, the control signal includes a protocol code.

In an embodiment, the power consumption unit further comprises a memory. The memory is coupled to the second processing unit for storing the protocol code.

In an embodiment, the second processing unit comprises a memory for storing the protocol code.

In an embodiment, the second processing unit further provides a switching signal according to the second voltage, and the power consumption unit further comprises a switch unit and a voltage conversion unit. The switch unit is coupled to the connecting unit and the second processing unit for conducting or disconnecting the switch unit according to the switching signal. The voltage conversion unit is coupled to the switch unit for converting the second voltage to an output working voltage when the switch unit is conducted.

The present invention will become more fully understood by reference to the following detailed description thereof when read in conjunction with the attached drawings.

### BRIEF DESCRIPTION OF THE DRAWINGS

The present disclosure will become more fully understood from the detailed description given herein below for illustration only, and thus are not limitative of the present disclosure, and wherein:

FIG. 1 is a block diagram of a power supply device for supplying power via internet network of the disclosure; and

FIG. 2 is a block diagram of another power supply device for supplying power via internet network of the disclosure.

### DETAILED DESCRIPTION

In view of the abovementioned problems, the disclosure provides a power supply device for supplying power via internet network, by which electrical devices can be supplied with high voltage power under switched-off status in order to enhance its convenience in application.

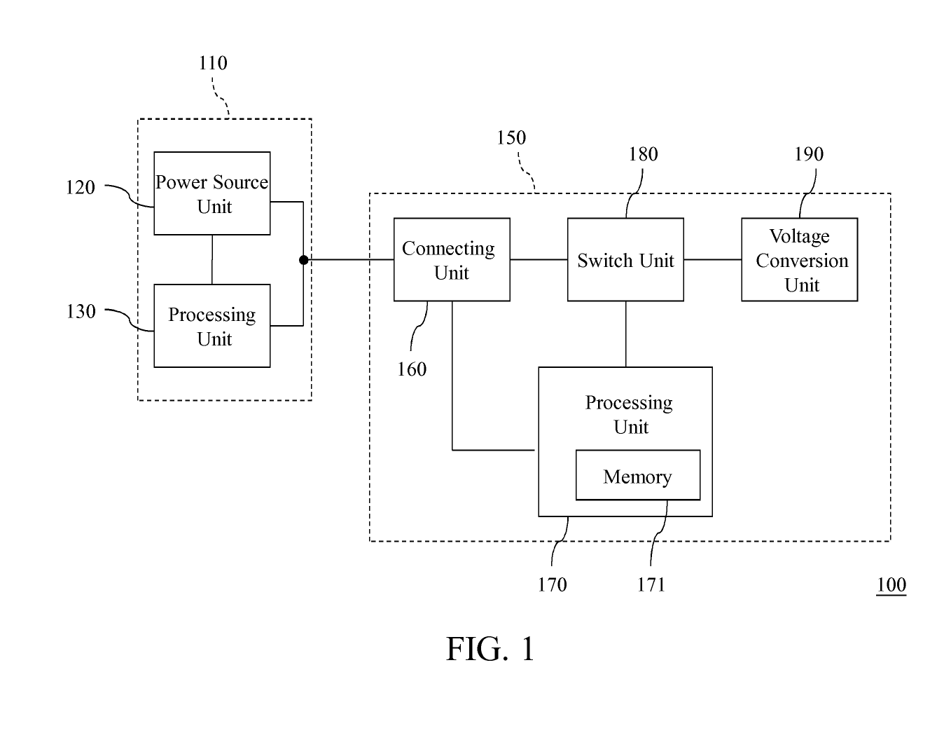

Referring to FIG. 1, which is a block diagram of a power supply device for supplying power via internet network of the disclosure. A power supply device for supplying power via internet network 100 of this embodiment is applicable for use in Power over Ethernet (POE). The power supply device for supplying power via internet network 100 comprises a power supply unit 110 and a power consumption unit 150. The power supply unit 110 can be a power sourcing equipment (PSE) for POE, the power consumption unit 150 can be an electronic device such as a tablet computer, a laptop or a desktop computer.

The power supply unit 110 comprises a power source unit 120 and a processing unit 130. The power source unit 120 provides a first voltage with a first power and a second voltage with a second power. In this embodiment, the first power and the second power are different from each other; the first power is, for example, 12.95 W, the second power is, for example, 25 W.

The processing unit 130 is coupled to the power source unit 120 for detecting a connection status of the power supply unit 110 for controlling the power source unit 120 to provide the first voltage, In other words, when a connection between the power supply unit 110 and the power consumption unit 150 is detected by the processing unit 130, the processing unit 130 generates, for example, an enable signal for the power source unit 120, so that the power source unit 120 provides the first voltage for the power consumption unit 150. Furthermore, the processing unit 130 can further generates, for example, another enable signal to control the power source unit 120 to provide the second voltage according to a control signal.

The power consumption unit 150 comprises a connecting unit 160 and a processing unit 170. The connecting unit 160 is for connecting the power source unit 120 and the processing unit 130. In other words, the power consumption unit 150 can be connected to the power supply unit 110 via the connecting unit 160, so as to be supplied with the first voltage and the second voltage provided by the power supply unit 110, so that internal components of the power consumption unit 150 can be operated normally. In this embodiment, the connecting unit 160 can be an Ethernet socket such as a RJ-45 socket for receiving and transmitting the first voltage or the second voltage provided by the power source unit 120.

The processing unit 170 is coupled to the connecting unit 160 for receiving the first voltage provided by the power source unit 120 via the connecting unit 160, and the processing unit 170 starts to operate according to the first voltage for providing the control signal. The control signal is transmitted to the processing unit 130 via the connecting unit 160, and the processing unit 130 receives the control signal to control the power source unit 120 to provide the second voltage for the power consumption unit 150, so that the power consumption unit 150 can be operated with a higher voltage power.

The control signal includes a protocol code such as the Link Layer Discovery Protocol (LLDP) firmware code (FW code). After the processing unit 130 has received the control signal with the protocol code, a communication of the Link Layer Discovery Protocol between the processing units 130 and 170 is completed, so that the processing unit 130 controls the power source unit 120 to provide the second voltage (with the second power, 25.5 W) for the internal components of the power consumption 150 to operate normally.

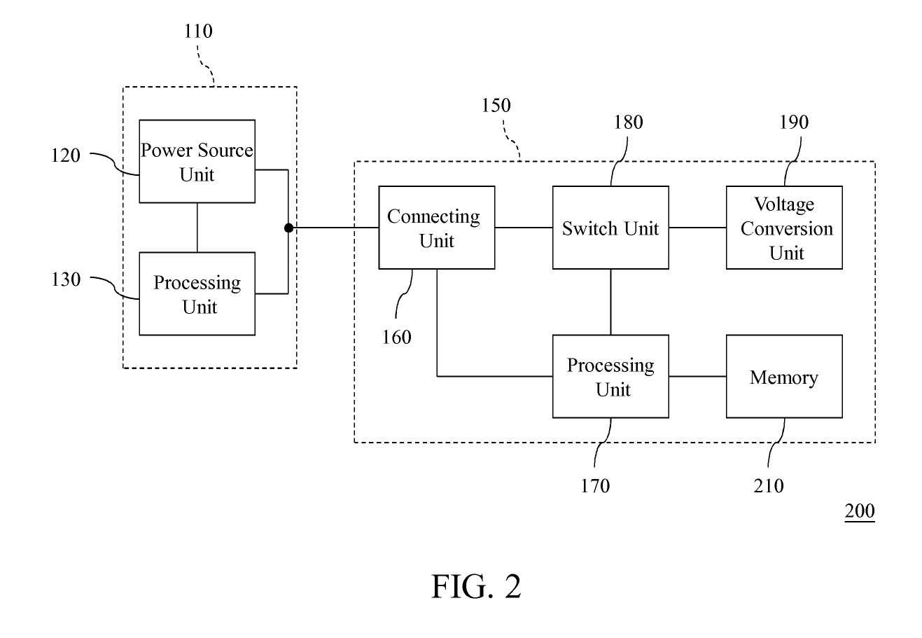

In this embodiment, the processing unit 170 can include a memory 171, which means the memory 171 is built into the processing unit 170. The memory 171 is for storing the protocol code. In other words, the processing unit 170 starts to operate after receiving the first voltage, then it reads the protocol code from the memory 171, and uses the control signal to transmit the protocol code to the processing unit 130 for executing subsequent operations. In another embodiment, the power consumption unit 150 can include a memory 210 as shown in FIG. 2. The memory 210 is coupled to the processing unit 170 or storing the protocol code. The memory 210 and the processing 170 are disposed separately, that is, the memory 210 is externally connected with the processing unit 170.

Furthermore, the power consumption unit 150 further comprises a switch unit 180 and a voltage conversion unit 190. The switch unit 180 is coupled to the connecting unit 160 and the processing unit 170 for conducting or disconnecting the switch unit 180 according to a switching signal generated by the processing unit 170. For example, when the processing unit 170 has not detected and received the second voltage, it generates, for example, a switching signal of low logic level, to disconnect the switch unit 180, so that a connection between the connecting unit 160 and the voltage conversion unit 190 is disconnected; when the processing unit 170 has detected and received the second voltage, it generates, for example, a switching signal of high logic level, to conduct the switch unit 180, so that the connecting unit 160 and the voltage conversion unit 190 are connected.

The voltage conversion unit 190 is coupled to the switch unit 180. When the switch unit 180 is conducted and, therefore, the voltage conversion unit 190 is connected with the connecting unit 160, the voltage conversion unit 190 converts the second voltage to a working voltage, so that the internal components of the power consumption unit 150 can operate normally using the working voltage with the second power. Thereby, the power supply device for supplying power via internet network 100 of this embodiment can receive a higher voltage power (i.e. the second power) directly without the system being turned on, so that the internal components of the power consumption unit 150 can operate normally, thus its convenience in application can be enhanced.

According to an power supply device for supplying power via internet network of the disclosure, when the power supply unit and the power consumption unit are connected, the first voltage with the first power is detected and received by the processing unit of the power consumption unit for providing the control signal with the protocol code to the processing unit of the power supply unit, so as to control the power source unit of the power supply unit for providing the second voltage with the second power. Thereby, the second voltage can be provided for the internal components of the power consumption unit for starting up and operating, in order to enhance its convenience in application.

Note that the specifications relating to the above embodiments should be construed as exemplary rather than as limitative of the present invention, with many variations and modifications being readily attainable by a person of average skill in the art without departing from the spirit or scope thereof as defined by the appended claims and their legal equivalents.

What is claimed is:

1. An power supply device for supplying power via internet network, comprising:
a power supply unit comprising:
a power source unit configured to provide a first voltage with at least one first power and a second voltage with a second power; and
a first processing unit coupled to the power source unit for detecting a connection status of the power supply unit for controlling the power source unit to provide the first voltage, and the first processing unit configured to control the power source unit to provide the second voltage according to a control signal; and
a power consumption unit, comprising:
a connecting unit for connecting the power source unit and the first processing unit; and
a second processing unit coupled to the connecting unit for receiving the first voltage via the connecting unit and providing the control signal according to the first voltage.

2. The power supply device for supplying power via internet network as claimed in claim 1, wherein the control signal includes a protocol code.

3. The power supply device for supplying power via internet network as claimed in claim 2, wherein the power consumption unit further comprises a memory coupled to the second processing unit to store the protocol code.

4. The power supply device for supplying power via internet network as claimed in claim 2, wherein the second processing unit comprises a memory to store the protocol code.

5. The power supply device for supplying power via internet network as claimed in claim 1, wherein the second processing unit is further configured to providing a switching signal according to the second voltage, the power consumption unit further comprises:
a switch unit coupled to the connecting unit and the second processing unit for conduct or disconnect the switch unit according to the switching signal; and
a voltage conversion unit coupled to the switch unit for converting the second voltage to an output working voltage when the switch unit is conducted.

6. The power supply device for supplying power via internet network as claimed in claim 1, wherein the power supply unit is a power sourcing equipment for Ethernet.

7. The power supply device for supplying power via internet network as claimed in claim 1, wherein the power consumption unit is an electronic device.
